(19) United States
(12) Patent Application Publication
(10) Pub. No.: US 2013/0246161 A1
(43) Pub. Date: Sep. 19, 2013

(54) SYSTEMS AND METHODS FOR OPTIMIZATION-AWARE DELIVERY PACING ADJUSTMENT IN ADVERTISEMENT SERVING

(71) Applicants: Jason Zien, Monte Sereno, CA (US); Erik Vee, San Mateo, CA (US); Sergei Vassilvitskii, New York, NY (US); Srinath Mandalapu, Santa Clara, CA (US); Marco Manfai Yu, Livermore, CA (US); Peiji Chen, Saratoga, CA (US); Chandrashekhar Nagarajan, Santa Clara, CA (US); Wenjing Ma, Sunnyvale, CA (US)

(72) Inventors: Jason Zien, Monte Sereno, CA (US); Erik Vee, San Mateo, CA (US); Sergei Vassilvitskii, New York, NY (US); Srinath Mandalapu, Santa Clara, CA (US); Marco Manfai Yu, Livermore, CA (US); Peiji Chen, Saratoga, CA (US); Chandrashekhar Nagarajan, Santa Clara, CA (US); Wenjing Ma, Sunnyvale, CA (US)

(73) Assignee: Yahoo! Inc., Sunnyvale, CA (US)

(21) Appl. No.: 13/423,025

(22) Filed: Mar. 16, 2012

(51) Int. Cl. G06Q 30/02

(52) U.S. Cl. 705/14.43

(57) ABSTRACT

Systems and methods for adjusting online ads delivery pace derive, in a computer system, a current impression delivery for an ads display contract. A plurality of estimation bands are delivered corresponding to over delivery and under delivery for the ads display contract. A relative distance is determined between the current impression delivery and the plurality of estimation bands. An adjustment factor is selected according to the relative distance. The adjustment factor is sent to a database.

### FIELD

This application relates generally to serving online ads. More particularly, it relates to a system that adjusts online ads delivery pace based on estimated delivery impressions.

### BACKGROUND

Online ads serving relate to the technology and service that serves advertisements on web sites. Ad serving technology companies provide software to web sites and advertisers to serve ads, count them, choose the ads that make the website or advertiser most money, and monitor progress of different advertising campaigns.

An online ads system can include a computer server such as a web server or an ads server that stores advertisements used in online marketing and delivers them to website visitors. Additionally, the online ads system may include a plurality of servers connected to each other in the background.

Online ads systems may need a long time to collect and analyze the ads delivery statistics from different web pages across the world. The online ads system may need to get ads delivery statistics fast enough to adjust online ads delivery pace. An ads display contract may get over delivery or under delivery because of the lack of pace adjustment.

### SUMMARY

One embodiment discloses a computer implemented method or program for adjusting online ads delivery pace. The computer implemented method is implemented by a computer system and includes the following steps. The computer system derives a current impression delivery for an ads display contract. The computer system derives a plurality of estimation bands corresponding to over delivery and under delivery for the ads display contract. The computer system determines a relative distance between the current impression delivery and the plurality of estimation bands. The computer system selects an adjustment factor according to the relative distance. The computer system sends the adjustment factor to a database.

A second embodiment discloses a computer implemented method or program for serving online ads. The computer implemented method is implemented by an online computer system and includes the following steps. The online computer system derives an adjustment factor for an ads candidate from a database. The online computer system derives a probability for the ads candidate based on the adjustment factor. The online computer system serves online ads based on the derived probability. The adjustment factor is determined according to a relative distance between a current impression delivery for an ads display contract and a plurality of estimation bands comprising an upper estimation band and a lower estimation band corresponding to over delivery and under delivery for the ads display contract.

Another embodiment discloses a computer system including a first and second server. The first server is configured to: derive an impression delivery for an ads display contract; derive a plurality of estimation bands comprising an upper estimation band and a lower estimation band corresponding to over delivery and under delivery for the ads display contract; determine a relative distance between the current impression delivery and the plurality of estimation bands; select an adjustment factor according to the relative distance; and send the adjustment factor to a database in the second server that selects ads for serving.

### BRIEF DESCRIPTION OF THE DRAWINGS

FIG. 1 is a block diagram of one embodiment of an environment in which a system for serving online ads may operate.

FIG. 2 is a flow chart of an embodiment of the computer implemented method for adjusting online ads delivery pace.

FIG. 3 illustrates an example showing the plurality of estimation bands and the current deliver.

FIG. 4 is a flow chart of an embodiment of the computer implemented method for serving online ads.

### DETAILED DESCRIPTION OF THE DRAWINGS

To improve the online ads delivery efficiency and thus increase the profit from serving online ads, it may be desirable to develop additional systems and methods for serving online ads with prompt delivery pace adjustment.

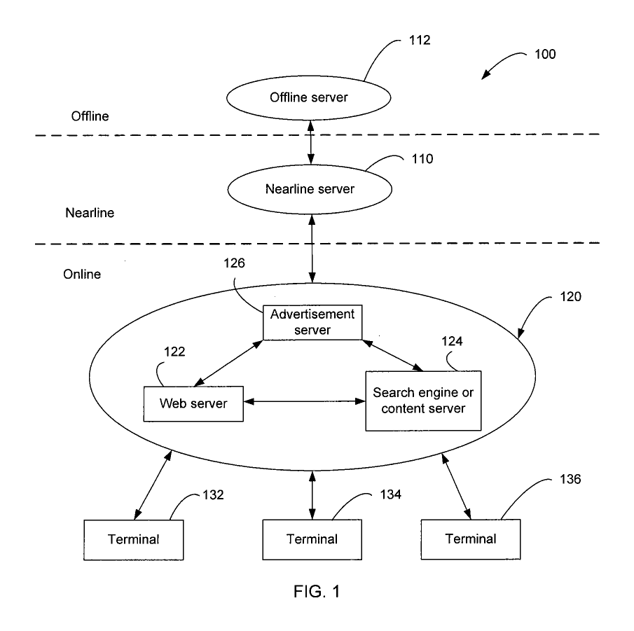

FIG. 1 is a block diagram of one embodiment of an environment in which a system for serving online ads may operate. However, it should be appreciated that the systems and methods described below are not limited to use with the particular environment in the drawing.

The environment 100 may include a nearline server 110 and an online server system 120 including a web server 122, a search engine or content server 124, and an advertisement server 126. The nearline server 110 may include a computer, a server, or any other computing device that runs almost in real time. The nearline server 110 may also include nearline storage devices. The nearline server 110 may be connected with other offline servers or online servers.

The web server 122 may be a computer, a server, or any other computing device, or the web server 122 may be a computer program, instructions, and/or software code stored on a computer-readable storage medium that runs on a processor of a single server, a plurality of servers, or any other type of computing device. The web server 122 delivers content, such as a web page, using the Hypertext Transfer Protocol and/or other protocols. The web server 122 may also be a virtual machine running a program that delivers content. The search engine or content server 124 may be a computer system, one or more servers, or any other computing device, or the search engine or content server 124 may be a computer program, instructions, and/or software code stored on a computer-readable storage medium that runs on a processor of a single server, a plurality of servers, or any other type of computing device. The search engine or content server 124 is designed to help users find information located on the Internet or an intranet.

The advertisement server 126 may be a computer system, one or more servers, or any other computing device, or the advertisement server 126 may be a computer program, instructions and/or software code stored on a computer-readable storage medium that runs on a processor of a single server, a plurality of servers, or any other type of computing device. For example, the advertisement server may include a guaranteed delivery front end (GDFE) that selects an ad for a given impression from ads candidates based on display conditions requested by the advertiser and adjustment factors from the nearline server 110. The advertisement server 126 also includes a database configured to store statistic information and adjustment factors for each ads display contract. The advertisement server 126 is also configured to serve the selected online ads to a web user. Alternatively or additionally, the advertisement server 126 is configured to send the selected online ads to the web server 122 or the search engine or content server 124, or both of them.

The advertisement server 126 may include a contract matching server having a search index of all the ads display contracts (booked ads) in the whole system. Given a query (which is an impression), the search contract matching server finds all the ads display contracts that can match that impression. The contract matching server returns the entire set of ads that can be shown to a user visit to a page. The entire set of ads may be referred to as ads candidates.

The environment 100 may further include a plurality of terminals 132, 134, and 136. The terminals may be a computer, a tablet, a smart phone, a personal digital aid, a digital reader, a Global Positioning System (GPS) receiver, or any other terminal that may be used to access the Internet.

Generally, an advertiser or any other user can use a terminal to access information on the server system 120. For example, when an Internet user utilizes one of the terminals 132, 134, 136 to submit a search query to the search engine or content server 124, the search engine or content server 124 may return a plurality of search results to the Internet user. The advertisement server 126 may additionally serve one or more online ads to the Internet user based on search terms provided by the Internet user. In addition or alternatively, when an Internet user utilizes one of the terminals 132, 134, 136 to view a website served by the web server 122, the advertisement server 126 may serve one or more online ads to the Internet user based on keywords obtained from the content of the website. The disclosed method may also apply to displaying ads on webpages, in games, or in any other situations or platforms with the need to display ads to potential customers.

The advertiser may purchase online ads based on an auction model of buying ad space or a guaranteed delivery model by which an advertiser pays a minimum Cost per mille (CPM) to display the digital ad. The CPM estimates the cost per 1000 views of the ad. For each ads display contract, it is preferred to finishing the delivery according to the contract terms as close as possible. For example, if the contract terms include a specific number of deliveries during a period of time, it is preferred to deliver the specific number of deliveries on the end date. However, it is almost impossible to obtain such an ideal delivery for all the ads display contracts because there may be thousands of computer servers involved in the process and it takes hours to obtain the actual delivery statistics for all the ads display contracts from all the involved computer servers.

Thus, the disclosure provides a method to estimate the delivery statistics for all ads display contracts implemented in the nearline server 110. The nearline server 110 can derive estimated delivery statistics for all ads display contracts in a few minutes. Thus, with the estimated delivery statistics and the most recent actual delivery statistics from an offline server 112, the nearline server 110 derives a current delivery for each ads display contract.

The offline server 112 includes a slow path optimizer that is configured to count the delivered impressions and output an allocation plan according to the counted delivered impressions. The slow path optimizer runs a global optimization calculation to derive the original probability for selecting an ads contract candidate. The original probability takes into account per-contract values derived based on all ads display contracts in the system. For example, suppose the time is now 5 PM UTC. This process may take the slow optimizer several hours to finish and thus there is a several hour lag introduced into the ads delivery system. Thus, the allocation plan output from the offline server is called as “slow path allocation plan.” In this example, the slow path allocation plan has the real delivered impressions as of about 2 PM UTC because there is a several hour lag in the processing and counting of delivered impressions as well as running of the slow path optimizer.

The nearline server 110 derives fast statistics for the time period of 2 PM UTC to 5 PM UTC. Because this fast statistics do not go through the full statistics processing pipeline such as traffic protection (TP). An approximate loss rate a is applied to the fast statistics. The approximate loss rate a adjusts for the TP which filters out fraudulent or robotic traffic. The approximate loss rate a may be set to a number between 0.1 and 1, for example, 0.9. The nearline server then output an estimated current delivery which is the sum of the real delivered impressions and the product of the approximate loss rate a and the delivery estimate from the fast statistics.

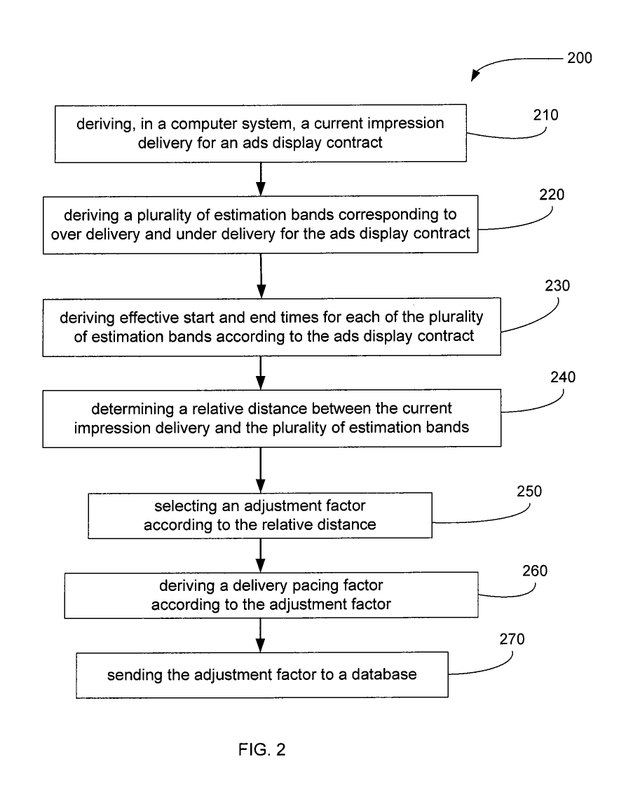

FIG. 2 is a flow chart of an embodiment of the computer implemented method 200 for adjusting online ads delivery pace. The computer implemented method 200 is configured to process all the ads display contracts including the contracts just added. In block 310, a computer system derives a current impression delivery for an ads display contract. The current impression delivery takes input from the above mentioned fast statistics and the real delivered impressions from the offline server 112 in FIG. 1.

In block 220, the computer system derives a plurality of estimation bands corresponding to over delivery and under delivery for the ads display contract. The plurality of estimation bands may include different bands during different time periods. For example, the plurality of estimation bands may have a first plurality of bands for the first half of the contract term. The plurality of estimation bands may also have a second plurality of bands for the last day of the contract term. The bands corresponding to over delivery can include upper bands and the bands corresponding to under delivery can include lower bands. The upper and lower bands never intersect with each other. Each estimation band may have different shapes including one or a combination of the following: straight lines, curves, and continuous lines. The plurality of estimation bands are determined based on experiment data.

In block 230, the computer system derives effective start and end times for each of the plurality of estimation bands according to the ads display contract. The effective start and end times may change based on whether the ads display contract is paused by the advertiser or other contract terms or instructions for each individual advertiser.

In block 240, the computer system determines a relative distance between the current impression delivery and the plurality of estimation bands.

In block 250, the computer system selects an adjustment factor according to the relative distance. If the current delivery is within upper bands based on the relative distance, the computer system selects the adjustment factor corresponding to the upper band just below the current delivery. If the current delivery is within lower bands, the computer system selects the adjustment factor corresponding to the lower band just above the current delivery. If the current delivery is not above any upper bands or below any lower bands, the computer system selects the adjustment factor to be 1.0.

In block 260, the computer system may further derive a delivery pacing factor according to the adjustment factor. The delivery pacing factor may take into account of other factors such as manual acceleration option selected by an advertiser on a user interface. The delivery pacing factor also includes a first adjustment factor if the current impression delivery is above an upper estimation band corresponding to the first adjustment factor. The delivery pacing factor includes a second adjustment factor if the current impression delivery is below a lower estimation band corresponding to the second adjustment factor.

In block 270, the computer system sends the adjustment factors to a database. The computer system may also send the delivery pacing factors with the adjustment factors. The database may be connected to the online server system 120. For example, the database may be located in the advertisement server 126. The online server system 120 can then derive a new probability for the ads display contract in the database by multiplying an original probability by the adjustment factor if the ads display contract is eligible as an ads candidate for displaying. The original probability may be an output from the offline server 112 or from previous fast statistics from the nearline server 110. With the new probability for all ads candidates, the advertisement server 126 selects one of the ads candidate based on the corresponding new probability. For example, if there were 2 competing ads display contracts which have probabilities 75% and 25%, the advertisement server 126 randomly selects in such a way that the first one would get selected 75% of the time and the second one would get selected 25% of the time. This may be implemented by several different ways. In one example, the advertisement server 126 generates a random number uniformly distribute between 0 and 1, if the random number is less than 0.75, the first ads display contract is selected and otherwise the second ads display contract is selected.

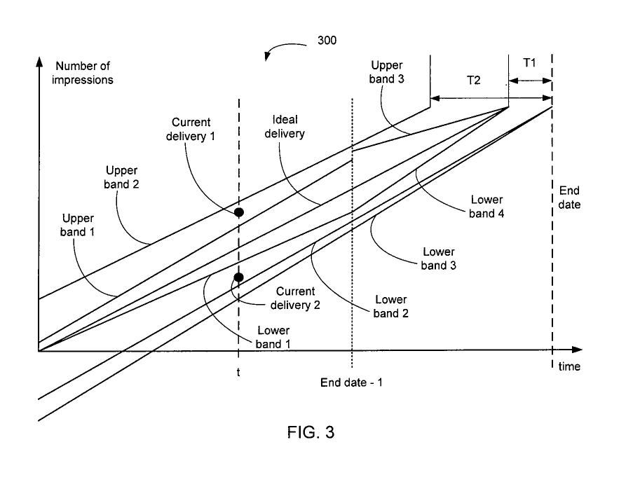

FIG. 3 illustrates an example showing the plurality of estimation bands and the current deliveries for two contracts. In FIG. 3, at time t, current delivery 1 is the estimated current delivery for a first ads display contract and current delivery 2 is the estimated current delivery for a second ads display contract.

Assuming the plurality of estimation bands are the same for these two ads display contracts in this example, there are three upper bands above the ideal delivery line and four lower bands under the ideal delivery line. The upper band 1 and lower band 1 are linear during the period before the last day of the contract. The upper band 3 and lower band 4 are linear bands on the last day of the contract. The upper band 2 ends T2 hours before the contract end date. The ideal delivery line ends at T1 hours before the contract end date. For example, T1 may be four hours and T2 may be 12 hours. These time delays T1 and T2 give the online ads serve system some freedom to adjust delivery in the last period.

The first ads display contract is over delivered and the second ads display contract is under delivered. The computer system selects different adjustment factors for these two ads display contracts. The upper bands 1, 2, and 3 have corresponding adjustment factors less than 1. For example, the upper band 1 may have an adjustment factor of 0.1 and the upper bands 2 and 3 have adjustment factor of 0. Thus, the computer system selects 0.1 for the first ads display contract because the estimated delivery 1 is just above upper band 1. Accordingly, the lower bands 1, 2, 3, and 4 have corresponding adjustment factors greater than 1. For example, the lower bands 1 and 4 may have the same adjustment factor of 3.0 and the lower bands 2 and 3 have adjustment factors of 5.0 and 10.0. Thus, the computer system selects 3.0 for the second ads display contract because the estimated delivery 2 is just below lower band 1. The shapes of the estimation bands may be different for different contracts and may include any other reasonable shapes.

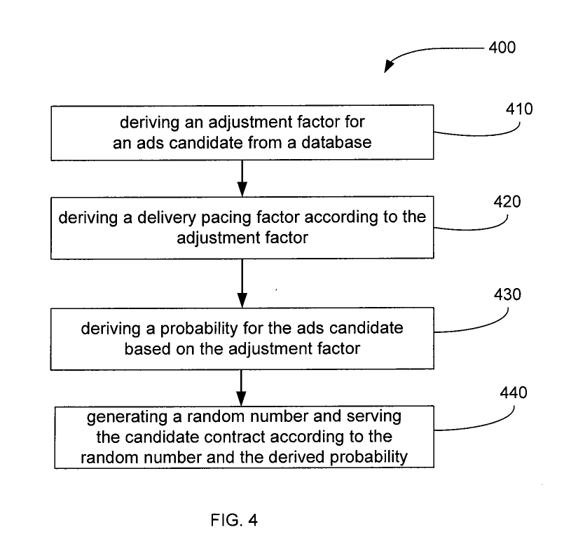

FIG. 4 is a flow chart of an embodiment of the computer implemented method 400 for serving online ads. The computer implemented method 400 may be implemented in the advertisement server 126 or other computer servers.

In block 410, the computer server derives an adjustment factor for an ads candidate from a database. This adjustment factors may be derived by a nearline computer server 110 in FIG. 1 according to the disclosed method 200 in FIG. 2.

In block 420, the computer server derives a probability for the ads candidate based on the adjustment factor. For example, the derived probability for the ads candidate is derived by multiplying an original probability by the adjustment factor. This may be implemented in two stages. In stage 1, all extra fractions from over delivery contracts are released by multiplying the adjustment factor by the original probability. In stage 2, all under delivery contracts are adjusted by multiplying the adjustment factor with the original probability. For example, suppose the original probability was 0.8, and the adjustment factor was 0.1 for an over delivery contract, then the derived probability is 0.8*0.1=0.08. Thus, the computed allocation fraction is 0.08 and the over delivery contract “released” 0.8−0.08=0.72 of what it wanted. Accordingly, the released portion allows other under delivery contracts to get more chance to be served.

In block 430, the computer server serves online ads based on the derived probability. The computer server selects one of the ads candidate based on the corresponding new probability.

In addition, a P-Fix act is introduced in cases of overbooking. In this P-Fix act, the derived probability may further be adjusted based on a quantity proportional to the demand of each ads display contract and the total supply of qualified impressions with a probability p. With probability 1−p, the derived probability is kept unchanged.

For example, in a popular website such as Yahoo! finance that has N impressions available. Now because it is so popular, the advertisers may have booked 100% of these N impressions with C ads display contracts. The system might even be overbooked. In such an overbooking case, some contracts may get starved because they have small derived probabilities and fall at the end of the allocation order. The P-Fix gives a p% chance for any contract to get selected, to avoid starvation issues. p% of the time, computer server allows the entire set of contracts to have some chance of being selected instead of just the ads candidates with a higher derived probabilities.

The disclosed computer implemented method may be stored in computer-readable storage medium. The method is accessible to at least one processor. The processor is configured to implement the stored instructions to adjust online ads delivery pace and serve ads on a webpage accordingly.

From the foregoing, it can be seen that the present embodiments provide an optimized solution to increase ads revenue by adjusting ads delivery near real time. The disclosed embodiments combine input from an offline optimizer and a nearline optimizer and output an adjustment factor for each ads display contract. Although the examples are implemented in a plurality of servers, the disclosed methods and systems may be configured differently for different applications.

It is therefore intended that the foregoing detailed description be regarded as illustrative rather than limiting, and that it be understood that it is the following claims, including all equivalents, that are intended to define the spirit and scope of this invention.

1. A computer implemented method for adjusting online ads delivery pace, comprising:
deriving, in a computer system, a current impression delivery for an ads display contract;
deriving a plurality of estimation bands corresponding to over delivery and under delivery for the ads display contract;
determining a relative distance between the current impression delivery and the plurality of estimation bands;
selecting an adjustment factor according to the relative distance; and
sending the adjustment factor to a database.

2. The computer implemented method of claim 1, further comprising deriving, in the computer system, effective start and end times for each of the plurality of estimation bands according to the ads display contract.

3. The computer implemented method of claim 1, wherein the plurality of estimation bands are determined based on experiment data.

4. The computer implemented method of claim 1, wherein the impression delivery is computed based on a number of delivered impressions during a first period and an estimate of delivered impressions during a second period.

5. The computer implemented method of claim 1, further comprising deriving a delivery pacing factor according to the adjustment factor, wherein the delivery pacing factor comprises a first adjustment factor if the current impression delivery is above an upper estimation band corresponding to the first adjustment factor, and wherein the delivery pacing factor comprises a second adjustment factor if the current impression delivery is below a lower estimation band corresponding to the second adjustment factor.

6. The computer implemented method of claim 4, further comprising deriving estimates of delivered impressions for newly added ads display contracts during the second period.

7. The computer implemented method of claim 1, further comprising deriving a new probability for the ads display contract in the database by multiplying an original probability by the adjustment factor if the ads display contract is eligible as an ads candidate for displaying.

8. The computer implemented method of claim 7, further comprising serving online ads according to the new probability.

9. A method for serving online ads, comprising:
deriving an adjustment factor for an ads candidate from a database;
deriving a probability for the ads candidate based on the adjustment factor; and
serving online ads based on the derived probability;
wherein the adjustment factor is determined by a computer system according to a relative distance between a current impression delivery for an ads display contract and a plurality of estimation bands comprising an upper estimation band and a lower estimation band corresponding to over delivery and under delivery for the ads display contract.

10. The method of claim 9, wherein the computer system derives effective start and end times for each of the plurality of estimation bands.

11. The method of claim 9, wherein the plurality of estimation bands comprise at least one of the following shapes: straight lines, curves, and continuous lines.

12. The method of claim 9, wherein the current impression delivery is derived based on a number of delivered impressions during a first period and an estimate of delivered impressions during a second period, wherein the second period has a short duration than the first period.

13. The method of claim 9, further comprising deriving a delivery pacing factor according to the adjustment factor.

14. The method of claim 9, wherein the computer system derives estimates of delivered impressions for new ads display contracts.

15. The method of claim 9, wherein the derived probability for the ads candidate is derived by multiplying an original probability by the adjustment factor.

16. The method of claim 15, further comprising: generating a random number and serving the candidate contract according to the random number and the derived probability.

17. A computer system, comprising:
a first server configured to: derive an impression delivery for an ads display contract; derive a plurality of estimation bands comprising an upper estimation band and a lower estimation band corresponding to over delivery and under delivery for the ads display contract; determine a relative distance between the current impression delivery and the plurality of estimation bands; select an adjustment factor according to the relative distance; and send the adjustment factor to a database in a second server that selects ads for serving.

18. The computer system of claim 17, wherein the second server is configured to select a candidate contract that meets impression conditions, derive a new probability for the ads display contract in the database by multiplying an original probability by a corresponding adjustment factor, and serve a candidate contract according to the new probability.

19. The computer system of claim 17, wherein the first server is configured to compute impression delivery based on a number of delivered impressions during a first period and an estimate of delivered impressions during a second period.

20. The computer system of claim 17, wherein the first server is in a nearline computer system and the second server is in an online computer system.
